(19) United States
(12) Patent Application Publication
(10) Pub. No.: US 2008/0242460 A1
(43) Pub. Date: Oct. 2, 2008

(54) GUIDE OR TENSIONING RAIL IN A TRACTION MECHANISM DRIVE

(75) Inventors: Jeff Hewitt, Windsor (CA); Lucian Botez, Novi, MI (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/060,975

(22) Filed: Apr. 2, 2008

Related U.S. Application Data
(60) Provisional application No. 60/909,526, filed on Apr. 2, 2007.

(51) Int. Cl. F16H 7/08; F16H 7/18

(52) U.S. Cl. 474/111

(57) ABSTRACT

A guide or tensioning rail in a traction mechanism drive is provided, wherein the guide or tensioning rail has a mounting eye with a sleeve. To simplify the assembly of the rail during assembly of the traction mechanism drive, the sleeve can be locked in the mounting eye.

### CROSS-REFERENCE TO RELATED APPLICATIONS

This application claims the benefit of U.S. Provisional Application No. 60/909,526, filed Apr. 2, 2007, which is incorporated herein by reference as if fully set forth.

### BACKGROUND

The invention relates to a guide or tensioning rail in a traction mechanism drive, wherein the rail has a mounting eye with a sleeve.

Traction mechanism drives are used, among other things, for transmitting rotational movements in internal combustion engines. For example, the rotation of a crankshaft can be transmitted with the help of the traction mechanism to camshafts or auxiliary assemblies of a vehicle. As traction mechanisms, belts, bands, V-belts, toothed belts, or chains are used. For guiding and also to keep the traction mechanism under sufficient biasing tension, it is known that the traction mechanism is guided with the help of at least one guide rail and a force is exerted on the traction mechanism with at least one tensioning rail, wherein this force acts essentially perpendicular to the direction of movement of the traction mechanism and also at the center of the traction mechanism drive. For this purpose, guide rails are typically mounted rigidly on another component, for example, an engine block. The tensioning rails are loaded with a spring force or by a hydraulic force and keep the traction mechanism under sufficient biasing tension, possibly also as a function of the rotational speed of the traction mechanism, in order to prevent, among other things, the traction mechanism from jumping from a drive wheel.

A tensioning rail for a chain drive is known, for example, from DE 199 13 288 A1. It is formed from an elongated and hollow base body, which is filled with a metal foam. Here, the tensioning rail can be mounted to an engine block by a bolt, which passes through a receptacle borehole. The production of such a tensioning rail, however, requires considerable expense in terms of production due to the pour-and-set foaming.

DE 199 23 923 A1 further discloses a tensioning rail, which provides a mounting eye, in which a metal sleeve is arranged. If the base body of the tensioning rail is produced, for example, from plastic, then damage to the tensioning rail during the mounting to an engine block or the like is avoided with the metal sleeve in the mounting eye, because the metal sleeve is significantly more stable than the plastic material of the tensioning rail itself. Here, the metal sleeve can be pressed or sunk into the mounting eye or it can be extrusion-coated with plastic.

Here, it is considered disadvantageous that for inserting the sleeve into the mounting eye, additional tools, for example, for an ultrasonic welding process, are needed, so that the tensioning rail can also be produced only with considerable expense.

### SUMMARY

The invention is based on the objective of creating a guide or tensioning rail for a traction mechanism drive, which can nevertheless be produced in a simple way with sufficient fatigue strength.

The invention is based on the knowledge that through the simple latching or locking of a metallic sleeve in a mounting eye of the guide or tensioning rail, the production process of this part can be simplified considerably. Corresponding catch devices can be formed in an arbitrary way, but preferably as described in the following. In principle, it is even possible that the individual parts, that is, the rail or the rail base body and the sleeve, are stored separately and assembled for the first time during the assembly of the traction mechanism drive, for example, during motor vehicle production.

In the scope of the invention, the guide or tensioning rail can have either an essentially one-piece construction or, for example, a two-piece construction. In the latter case, the actual contact or sliding surface, which is in contact with the moving traction mechanism, is made from a first material which offers low friction as a function of the material selection of the traction mechanism. The actual rail base body can be constructed from another material, in order to impart sufficient strength to the guide or tensioning rail for a relatively low weight.

According to one improvement, it is provided that the guide or tensioning rail is made from a plastic material and the sleeve is made from a metal or a metallic alloy. Here, the sleeve is constructed with sufficient dimensioning, in order to prevent destruction of the sleeve during the mounting of the guide or tensioning rail, for example, on an engine block or during proper operation. For this purpose, a threaded bolt or the like can extend through the sleeve and can be screwed into a correspondingly dimensioned threaded borehole in the engine block. Accordingly, the essential retaining forces, which are transferred from the threaded bolt to the guide or tensioning rail or to the sleeve, are received by the sleeve.

In order to hold the sleeve reliably in the mounting eye or to lock it with the base body of the guide or tensioning rail, catch devices are formed on the two end faces of the mounting eye or on both side cheeks of the guide or tensioning rail. In principle, a countersunk depression can also be provided in a side cheek of the tensioning rail for receiving the head of a threaded bolt. For mounting the sleeve in the mounting eye or in the guide or tensioning rail, the sleeve merely has to be inserted into the mounting eye and securely locked there against axial movement. This can also be performed for the first time at the final assembly of the guide or tensioning rail.

Preferably, the catch devices are each constructed in the form of a discontinuous, annular, or ring segment-shaped projection of the base body of the guide or tensioning rail, wherein this projection runs around the opening of the mounting eye and points radially inward into the mounting eye opening. Here, these, for example, discontinuous, annular projections viewed in the axial direction through the mounting eye are arranged, in particular, in such a way that the catch projections do not overlap each other with respect to the periphery on the opposing end sides. Thus, the sleeve can be pushed from one side into the mounting eye and locked in both end-face catch devices.

For the construction of the sleeve, it is provided according to another variant that this has an essentially cylindrical construction with cylindrical and also smooth inner and outer surfaces. In order to guarantee optimum interaction with the mentioned catch devices, the sleeve also has beveled edges at the outer edges of both end faces viewed in the radial direction, wherein the beveled edges are preferable oriented at an angle of 45° to the longitudinal axis of the sleeve. Such a beveled sleeve can be easily inserted into the mounting eye and can interact with the help of the previously described annular, preferably discontinuous catch projections, so that the sleeve is held somewhat captively in the guide or tensioning rail.

To be able to install the guide and tensioning rail in arbitrary positions in a stationary and pivoting way, it has two mounting eyes, wherein one mounting eye is passed through by a threaded bolt for attaching to a stationary component, and a coupling element of an actuator for loading the guide or tensioning rail can engage in the other mounting eye.

For compensating for tolerance errors and also for the correct adjustment, for example, of the guide or tensioning rail on an engine block, at least one of the mounting eyes is constructed as an elongated hole, in order to be able to move the sleeve back and forth within this elongated hole at least to some degree. Subsequently, if the guide or tensioning rail is mounted on the engine block, e.g., with the help of a threaded bolt, then dimensional tolerances can be compensated through a slight back-and-forth movement of the sleeve in the elongated hole and the subsequent tightening of the threaded bolt. In principle, two or more mounting eyes can also be constructed as elongated holes, wherein for two mounting holes, an arrangement of the elongated holes oriented perpendicular to each other is provided.

In the same way, for fine adjustment and also for compensating for dimensional errors, the outer diameter of the sleeve can be slightly smaller than the inner diameter of the mounting eye, in order to similarly provide here a certain clearance for the assembly. This difference, however, should not be too large, in order to avoid tilting of the sleeve within the mounting eye.

Furthermore, in a similar manner, the length of the sleeve viewed in the axial direction can be slightly smaller than the depth of the mounting eye or the width of the guide or tensioning rail. Preferably, it is to be provided that this difference in length equals at least 0.5% of the maximum length of the sleeve or the minimum depth of the mounting eye, under consideration of the production tolerances. At the most, this difference in length should be selected to be 5% of the minimum height of the sleeve or the maximum depth of the mounting eye, under consideration of the production tolerances. For such dimensioning it is guaranteed that the plastic material is not destroyed under the axial load of a threaded bolt.

If, for such a construction, for example, a threaded bolt is inserted through the sleeve, in order to screw the guide or tensioning rail in a threaded bolt fixed in place, then the head of the threaded bolt comes in contact during tightening first with the plastic material of the guide or tensioning rail, because this projects axially slightly past the metallic sleeve. For further tightening, this plastic material becomes slightly compressed until the threaded bolt contacts the end face of the preferably metallic sleeve, which obviously has significantly greater strength than the plastic of the guide or tensioning rail.

Now, if the threaded bolt is tightened with sufficient torque, then the plastic material of the guide or tensioning rail is set slightly under pressure, wherein according to the differences in height described above for the individual components, too large a pressure is not exerted on this plastic material, so that destruction of the plastic material is prevented. In addition, through this construction it is achieved that in the guide or tensioning rail during operation no disruptive vibrations are generated, because the plastic material is pressed by the threaded head to a sufficient degree, for example, onto the engine block.

Due to the simple geometrical construction of the sleeve, which is formed essentially by a cylindrical body, this can also be produced economically. In particular, a powder metallurgical method can be used to produce such sleeves in mass production economically and with sufficient tolerances. For this purpose, metals or metal alloys can be used with grain sizes of, for example, below 0.6 mm, which can be formed in the desired shape in corresponding molds or pressing tools. Then a sintering process is performed by heat treatment. In principle, such a sleeve can also be produced through a powder injection molding process.

### BRIEF DESCRIPTION OF THE DRAWINGS

The invention will be explained in more detail in the following using embodiments with reference to the enclosed drawings. Shown therein are:

FIG. 1 is a perspective view of a guide rail according to the invention,

FIG. 2 is a cross-sectional view of a sleeve,

FIG. 3 is a side view of a guide rail,

FIG. 4a is a cross-sectional view of a mounting eye of the guide rail,

FIG. 4b is a top view of the mounting eye according to FIG. 4a,

FIG. 5a is a cross-sectional view of a sleeve inserted into the guide rail, and

FIG. 5b is a section view taken along line X-X through the projection of the guide rail according to FIG. 5a.

### DETAILED DESCRIPTION OF THE PREFERRED EMBODIMENTS

The guide rail 1 shown in FIG. 1 is made from a plastic base body 2 built like a framework and also a contact surface 3, on which a traction mechanism slides, for example, a chain for a camshaft drive. With such a guide rail 1, a traction mechanism of a traction mechanism drive can be guided. In principle, such a guide rail 1 can also be used for exerting a biasing tension onto the traction mechanism, wherein this is then supported as a tensioning rail so that it can pivot about a bearing point and is charged with a force in the direction toward the traction mechanism by an actuator that can be activated by a pressurized medium or a pressure spring.

Furthermore, the guide rail 1 provides two mounting eyes 4a, 4b, in each of which a metallic sleeve 5 is inserted. For mounting the tensioning rail 1, for example, onto an engine block of a motor vehicle, among other things, threaded bolts are passed through the sleeves 5 and screwed, e.g., into threaded boreholes in the engine block.

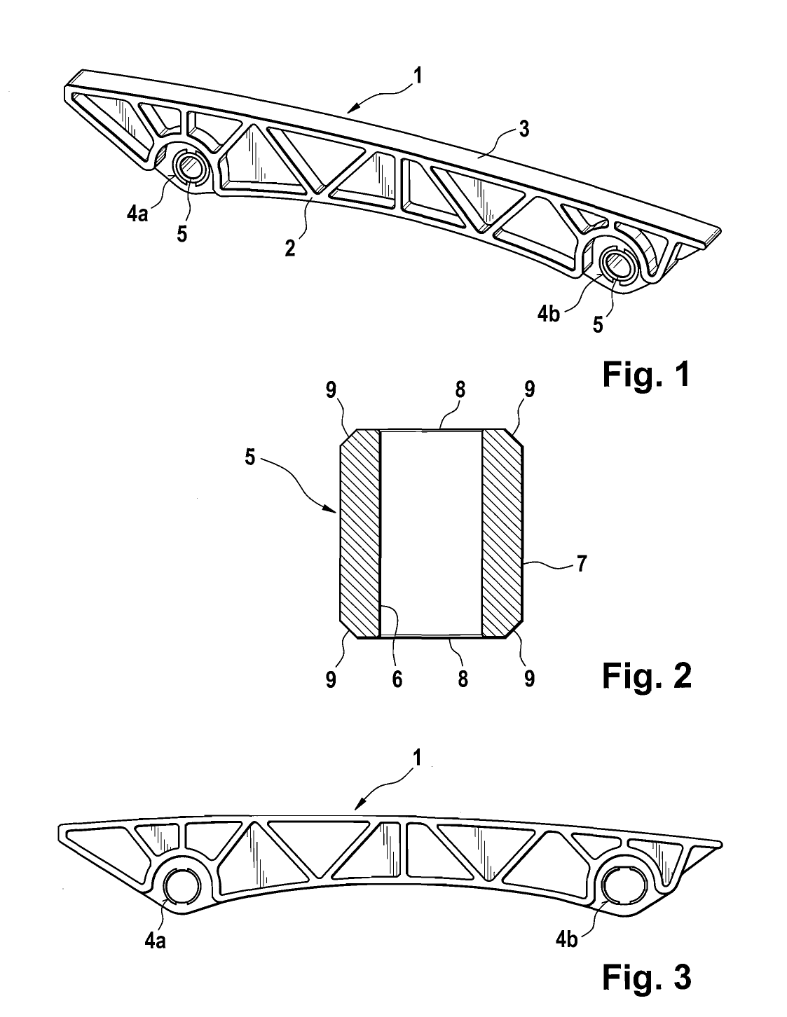

In FIG. 2, such a sleeve 5 is shown in cross section. The metallic sleeve 5 has an essentially cylindrical geometry, with an inner cylindrical surface 6 and an outer cylindrical surface 7. It is understood that the sleeve 5 is constructed with a corresponding material strength, in order to withstand the resulting operating loads. Furthermore, the sleeve 5 has opposing end faces 8, wherein beveled edges 9 are formed on the outer edges viewed in the radial direction of the sleeve 5.

It can be inferred from the view in FIG. 3 that the guide rail 1 has two geometrically different mounting eyes 4a, 4b, wherein the mounting eye 4a is constructed as an essentially circular mounting eye, while the mounting eye 4b has the shape of an elongated hole that deviates from the circular geometry. The function of these geometrically different mounting eyes has already been described in the brief description of the invention.

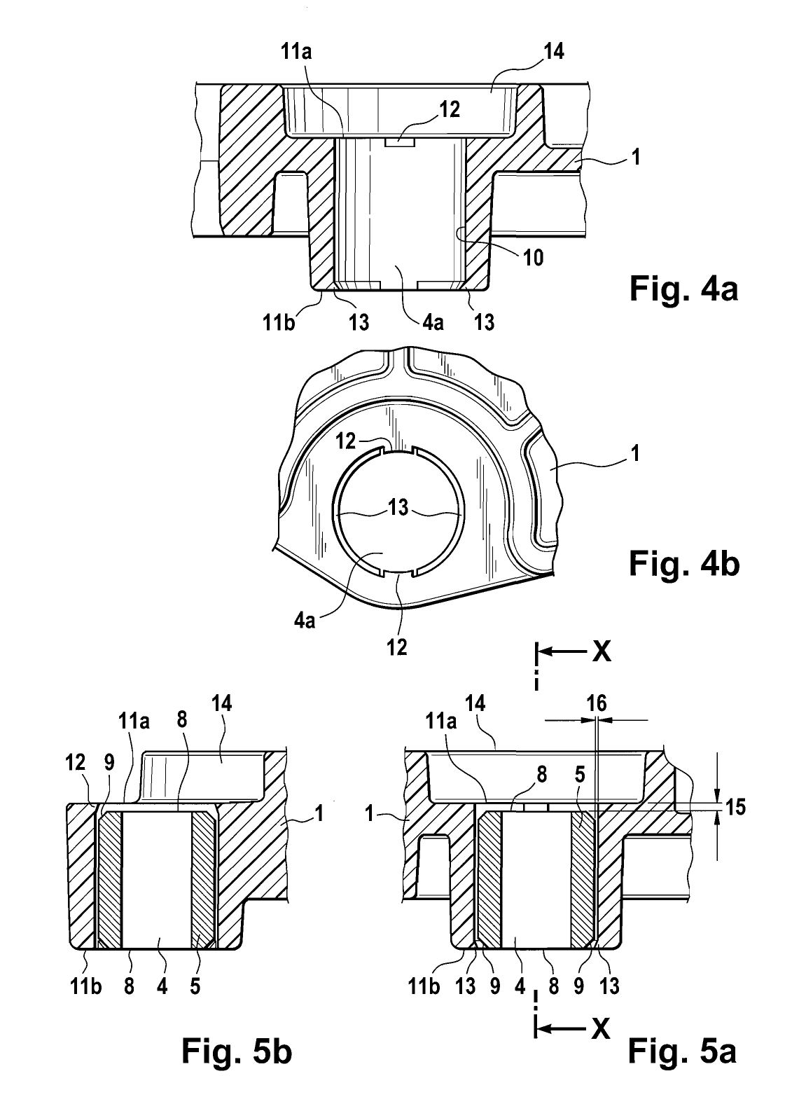

In FIGS. 4a and 4b, the mounting eye 4a of the tensioning rail 1 is shown in a cross section and in a top view, respectively. The mounting eye 4a has a cylindrical inner wall 10. On the two end faces 11a, 11b of the mounting eye 4a there are discontinuous, ring segment-shaped catch projections 12, 13, which have a discontinuous construction and are arranged in such a way that in top view, as shown in FIG. 4b, the catch projections 12 on one end face 11a do not overlap with the catch projections 13 on the end face 11b with respect to the periphery. Thus, it is possible to introduce a previously described sleeve 5 into the mounting eye 4a and to lock it on the catch projections 12, 13 with the help of the beveled edges 9. Therefore, no other tools or auxiliary means are needed to reinforce a mounting eye 4a of the plastic guide rail 1 with a metallic sleeve 5 and thus to protect the entire guide rail 1 from damage. In FIG. 4a, it can be further seen that a countersunk depression 14 is formed in the guide rail 1, in order to hold, for example, the head of a threaded bolt, which is guided through the sleeve 5, with flush surfaces.

In FIG. 5a, the sleeve 5 with the guide rail 1 is shown in cross section, while FIG. 5b shows a section along the line X-X of FIG. 5a. Shown is a metallic sleeve 5 inserted into the guide rail 1, wherein this sleeve 5 is constructed with a smaller axial length than the depth of the mounting eye 4 in the guide rail 1. Thus, an axial offset 15 is obtained.

If a threaded bolt (not shown here for simplifying the view) is guided through the sleeve 5 and screwed, e.g., into a threaded borehole of an engine block, then the head or a stop shoulder of the threaded bolt first comes into contact with the plastic material of the guide rail 1 or the end face 11a in the countersunk depression 14 and at least slightly compresses the plastic material for further tightening of the threaded bolt. This takes place until the preferably similarly metallic threaded bolt comes into contact on the end side 8 of the sleeve 5 and thus the guide rail 1 is fixed overall.

In this way, too much pressure is not exerted on the plastic material of the tensioning rail 1 by the threaded bolt, so that, in particular, no structural damage happens to the guide rail 1. However, this axial offset 15 is preferably selected in such a size or length that the guide rail 1 is pressed with sufficient retaining force, in order to prevent vibrations of the tensioning rail 1 at the retaining point.

Furthermore, the outer diameter of the sleeve 5 is slightly smaller than the inner diameter of the mounting eye 4, so that a radial offset 16 is also present, which is why the sleeve 5 can be moved with a certain play within the mounting eye 4. This can be used to compensate certain production tolerances and to precisely adjust the traction mechanism drive or the guide rail 1 for guiding the traction mechanism.

The sleeve 5 can be produced preferably using a powder metallurgical process due to its simple construction.

### LIST OF REFERENCE SYMBOLS

1 Guide rail, tensioning rail
2 Base body
3 Contact surface
4a Mounting eye, circular
4b Mounting eye, elongated hole-shaped
5 Sleeve
6 Inner cylindrical surface of the sleeve
7 Outer cylindrical surface of the sleeve
8 End face of the sleeve
9 Beveled edge on the sleeve
10 Inner wall of the mounting eye
11a End face of the mounting eye
11b End face of the mounting eye
12 Catch projection
13 Catch projection
14 Countersunk depression
15 Axial offset
16 Radial offset

1. Guide or tensioning rail for a traction mechanism drive, the guide or tensioning rail comprising a mounting eye with a sleeve that can be locked in the mounting eye.

2. Guide or tensioning rail according to claim 1, wherein the guide or tensioning rail is made from plastic and the sleeve is made from a metal.

3. Guide or tensioning rail according to claim 1, wherein a catch device is formed on both end faces of the mounting eye.

4. Guide or tensioning rail according to claim 3, wherein the catch device is constructed as a discontinuous, annular, or ring segment-shaped catch projection pointing inwardly in a radial direction.

5. Guide or tensioning rail according to claim 1, wherein the sleeve is essentially cylindrical and is provided with beveled edges on an outer edge of end faces thereof viewed in a radial direction.

6. Guide or tensioning rail according to claim 1, wherein the guide or tensioning rail has two mounting eyes, of which one of the mounting eyes has an elongated hole shape.

7. Guide or tensioning rail according to claim 1, wherein an outer diameter of the sleeve is slightly smaller than an inner diameter of the mounting eye.

8. Guide or tensioning rail according to claim 1, wherein an axial length of the sleeve is slightly smaller than a depth of the mounting eye.

9. Guide or tensioning rail according to claim 2, wherein the sleeve is a powder metallurgy formation.

10. Guide or tensioning rail according to claim 2, wherein the guide or tensioning rail has a two-piece construction, with a base body having the mounting eyes and a second component having a contact surface for contacting the traction mechanism, wherein the base body and second component are connected rigidly to each other.
